(19) United States
(12) Patent Application Publication
(10) Pub. No.: US 2014/0041003 A1
(43) Pub. Date: Feb. 6, 2014

(54) METHOD OF AND SYSTEM FOR GAINING SECURE ACCESS TO A SERVICE

(71) Applicant: Armin WAPPENSCHMIDT, Hamburg (DE)

(72) Inventor: Armin WAPPENSCHMIDT, Hamburg (DE)

(21) Appl. No.: 13/946,352

(22) Filed: Jul. 19, 2013

(30) Foreign Application Priority Data
Aug. 1, 2012 (EP) 12178889.7

(51) Int. Cl. H04L 29/06

(52) U.S. Cl. CPC H04L 63/083
USPC 726/7

(57) ABSTRACT

In order to gain secure access to a service in a defined trustworthy environment holding at least one network component a password is saved in the network component. Then a user device is introduced into the trustworthy environment, and it contacts the network component device and retrieves the password saved in the network component. The device then communicates the password to the service, which in turn is enabled for the user device if a password stored in the service matches the password that has been communicated by the user device to the service.

### FIELD OF THE INVENTION

The present invention relates to gaining secure access to a service. More particularly this invention concerns a method of and system for gaining such access in a defined trustworthy environment.

### BACKGROUND OF THE INVENTION

Methods of the above-described type are well known in practice. Security-related requirements frequently dictate that services must be enabled or the encrypted data must be decrypted before accessing certain services or encrypted data. Protecting certain services or data is necessary, in particular, whenever these devices are operated outside a defined trustworthy environment. Blocking or encrypting data can generally be omitted within a trustworthy environment since access to the service or data is effected exclusively by trustworthy authorized entities or users. The disadvantage inherent in the methods known in practice in this case is the fact that the services or data would then not be protected if the service is accessed outside the trustworthy environment or data are used outside the trustworthy environment. The approach in practice to avoid this problematic situation is thus to employ a password by which the services or data can be protected against unauthorized use. Following a predetermined period of inactivity in using the service or accessing the data, however, the password must be reentered, and this means that utilization of the service or the data is to some extent less user friendly.

### OBJECTS OF THE INVENTION

It is therefore an object of the present invention to provide an improved method of and system for gaining secure access to service.

Another object is the provision of such an improved method of and system for gaining secure access to service that overcomes the above-given disadvantages, in particular that is very user friendly.

### SUMMARY OF THE INVENTION

In order to gain secure access to a service in a defined trustworthy environment holding at least one network component a password is saved in the network component. Then a user device is introduced into the trustworthy environment, and it contacts the network component device and retrieves the password saved in the network component. The device then communicates the password to the service, which in turn is enabled for the user device if a password stored in the service matches the password that has been communicated by the user device to the service.

Within the scope of the invention, secure access refers to the fact that access to the service is protected against being achieved by an unauthorized entity. The service is, for example, an internet service, preferably, a web-mail service. It is possible for the service to be provided in the trustworthy environment in the form of access to a user account preferably on a local device, for example, a computer (PC).

In one embodiment, the service is a mass storage medium, for example, a file server and/or a network attached storage server (NAS server) including a preferably encrypted file system. The encrypted file system is preferably decrypted whenever secure access is enabled for the user device to use the mass storage medium. The file system of the mass storage medium is advantageously encrypted whenever the mass storage medium is used outside the trustworthy environment. By way of recommendation, the trustworthy environment is a network that is separated from the public Internet, preferably by a router. It is possible for the network to be provided by a computer.

It is recommended that the trustworthy environment be defined based on a reference data set that contains at least one data set composed of the group consisting of position data (GPS data), LAN data, Bluetooth data, network addresses, GSM wireless data, meteorological data. Position data within the scope of the invention refers to the coordinates or spatial range of the trustworthy environment. LAN data (local area network data) within the scope of the invention refers to at least one component, and preferably a plurality or all of the components that are in the trustworthy environment.

It is possible in principle for the LAN to comprise a wireless network (wireless LAN, WLAN) or to be in the form of a wireless network or WLAN. In one embodiment, the LAN data comprise receivable external WLAN signals and/or signal strengths and/or network identifiers of the components that are integrated in the WLAN. Receivable external WLAN signals comprise signals from networks that can be received within the trustworthy environment and that do not each constitute any components that are part of the trustworthy environment. Signal strength within the scope of the invention refers to signals that can be received by external WLANs and/or to signals that can be received by components coming from the trustworthy environment.

Network addresses within the scope of the invention include the addresses of components that are in the trustworthy environment. GMS data within the scope of the invention refers, for example, to the identity of a GSM-capable device that is located in the trustworthy environment that can be accessed by GSM wireless cells. Meteorological data are, for example, the current temperature and/or a past temperature profile. Bluetooth data comprise contact data of at least one Bluetooth-capable device that is in the trustworthy environment.

In order to locate the network components in the trustworthy environment, the data set defining the trustworthy environment is preferably compared with an integration data set supplied by the network components and that are integrated exclusively within the trustworthy environment only if a specified maximum deviation between the reference data set and the integration data set falls below a predetermined level. The integration data set comprises at least one data set, which data set is selected from the group consisting of position data (GPS data), LAN data, Bluetooth data, network addresses, GSM wireless data, meteorological data.

In an especially preferable approach, the data set contained in the integration data set is also a constituent part of the reference data set. The maximum deviation is preferably specified or specifiable, thereby allowing the security level of the method according to the invention to be adjusted. As the allowable deviation becomes higher, the security level accordingly becomes lower. The security level of the method according to the invention increases as the allowable deviation between the reference data set and the integration data set becomes smaller. The network component is preferably in the trustworthy environment or integrated into the trustworthy environment if the integration data set supplied by the network component is identical to the reference data set. In one embodiment, if the integration data set does not match the reference data set, or a specified deviation is exceeded between the integration data set and the reference data set, the network component is considered to be an external network component, or considered not to belong to the trustworthy environment. In this case, the network component is not a constituent part of the trustworthy environment. The network component advantageously has at least one sensor that can detect or determine the integration data set—preferably, the data sets contained in the integration data set or the data set contained in the integration data set. The sensor in one embodiment is a GPS sensor.

In order to introduce the user device into the trustworthy environment, it is recommended that the reference data set defining the trustworthy environment be compared with the entry data detected from the user device, and the user device is only considered to belong exclusively to the trustworthy environment if a specified maximum deviation between the reference data set and the entry data falls below a predetermined value. The entry data especially preferably matches the reference data set. The entry data detected from the user device comprises at least one data set that is contained in the reference data set. For example, the entry data include at least one data set selected from the group consisting of position data (GPS data), LAN data, Bluetooth data, network addresses, GSM wireless data, meteorological data. It is recommended that the user device have at least one sensor unit that can detect or determine the entry data. The sensor unit is advantageously a GPS sensor. A proven approach is for the data set by which the trustworthy environment is defined to be stored in the network component and/or the user device. In an especially preferred aspect, the network component uses the integration data set and the reference data saved in the network component to proactively determine whether the network component belongs to the trustworthy environment.

In an especially preferred aspect, the network component refuses to allow the user device to retrieve the password stored in the network component whenever the user device is located outside the trustworthy environment. The network component advantageously responds to a password request from the user device only when the user device has been introduced into or integrated into the trustworthy environment. Advantageously, no password is saved in the user device. Whenever the user device is located, for example, outside the trustworthy environment, the user is required to enter the password in order to use the user device to obtain secure access to the trustworthy environment and/or to the service. According to the invention, the network component refuses to allow the user device to retrieve the password stored in the network component if the network component is located outside the trustworthy environment. Whenever the integration data set determined by the network component exceeds a specified deviation from the reference data set, the network component refuses to disclose the password.

It has been found advantageous if at least two and preferably a plurality of network components is/are in the trustworthy environment, one respective part of the password being stored in each of the at least two network components of the trustworthy environments. One part of the password is preferably saved in each network component of the trustworthy environment. The parts of the password saved in the individual network components advantageously differ from each other. It is possible for at least two parts of the password to be the same, and optionally for all parts of the password to be the same or identical. It is possible for the address of the network component to be used as the password. Access to the service is possible with the password. In one embodiment, decryption of the file system is effected by the password that is preferably used as the decryption key.

The user device advantageously retrieves the parts of the password from those network components in which parts of the password are stored. It is recommended that the parts of the password retrieved by the user device be combined to form the password in the user device. In an especially preferred embodiment, the password is either not saved or is only temporarily saved in the user device. Addresses are preferably stored in the user device for the network component or network components to be contacted, from which network component the password is retrieved or from which parts of the password are retrieved.

According to the invention, retrieval of the password or the parts of the password is effected proactively by the user device as soon as the user device has been advantageously introduced into the trustworthy environment or into the service. If the user device has not been introduced into the trustworthy environment, and/or if a network component in which part of the password is stored is not in the trustworthy environment, according to the invention no access can be established proactively to the service by the user device. Within the scope of the invention, proactively means that the user device in terms of retrieval of a password automatically contacts the network component in the trustworthy environment and/or the network components in the trustworthy environment in order to retrieve the password stored in the network component or the parts of the password stored in the individual network components. It is possible for the user device to effect a retrieval of the password proactively only if the user device is in the trustworthy environment. It is recommended that the network component or the network components each proactively or independently determine whether they belong to the trustworthy environment.

In addition, the invention teaches a system for achieving the object of the invention, by which a service is securely accessible in a defined trustworthy environment. Here the defined trustworthy environment comprises at least one network component inf which a password is saved. A user device can be introduced into or integrated into the trustworthy environment, and effect a communication with the network component to retrieve the password. Then the user device communicates the password to the service, and the service is enabled for the user device if a password stored in the service matches the password communicated by the user device.

It is recommended that the trustworthy environment preferably be a private network. Within the scope of the invention, private network refers to a company network and/or a network in a private residence and/or a computer center. It is recommended that the network component be a passive network component. The network component is, for example, a DSL switch, a filter, an amplifier, or the like. Within the scope of the invention, passive network component refers, in particular, to the fact that this network component does not generate any data or signals.

It is possible for the network component to be an active network component. The active network component is at least one component that is selected from the group consisting of server, NAS server, Bluetooth device, printer, mass storage means. The user device is advantageously a network-capable device. In one embodiment, the user device is selected from the group consisting of portable computer (notebook), mobile telephone, smartphone, tablet PC.

It has been found advantageous for the password to contain a network address and/or part of a network address of a network component in the trustworthy environment. This approach ensures that no additional memory is required in the network component or in the network components in which the password must be stored. It is possible for the password to be composed of the network addresses or of parts of the network addresses of the individual network components that are integrated into the trustworthy environment.

The invention is based on the idea that the method according to the invention and the system according to the invention are characterized by a surprising ease of use and high degree of user friendliness. Frequently entering a password to enable access to a service is limited by the method according to the invention to situations in which the user device is not within a trustworthy environment. The method according to the invention makes it possible to eliminate the need to enter a password without compromising security whenever the user device is located in the trustworthy environment. The user device can be designed without any specially secured memory due to the fact that the individual components enabling access to the service are stored in the trustworthy environment. Since an unauthorized third party is unaware as to where and how the password is obtained in the method according to the invention or in the system according to the invention, unauthorized access to the service is impossible, or is possible only by costly means. As a result, the method according to the invention is characterized by a high level of security and surprising ease of use.

### BRIEF DESCRIPTION OF THE DRAWING

The above and other objects, features, and advantages will become more readily apparent from the following description, reference being made to the accompanying drawing in which:

FIG. 1 is a schematic diagram of a system according to the invention for carrying out the method according to the invention in which a user device is in a trustworthy environment; and

FIG. 2 is another such diagram showing a system according to the invention for carrying out the method according to the invention in which the user device is outside the trustworthy environment.

### DETAILED DESCRIPTION OF THE INVENTION

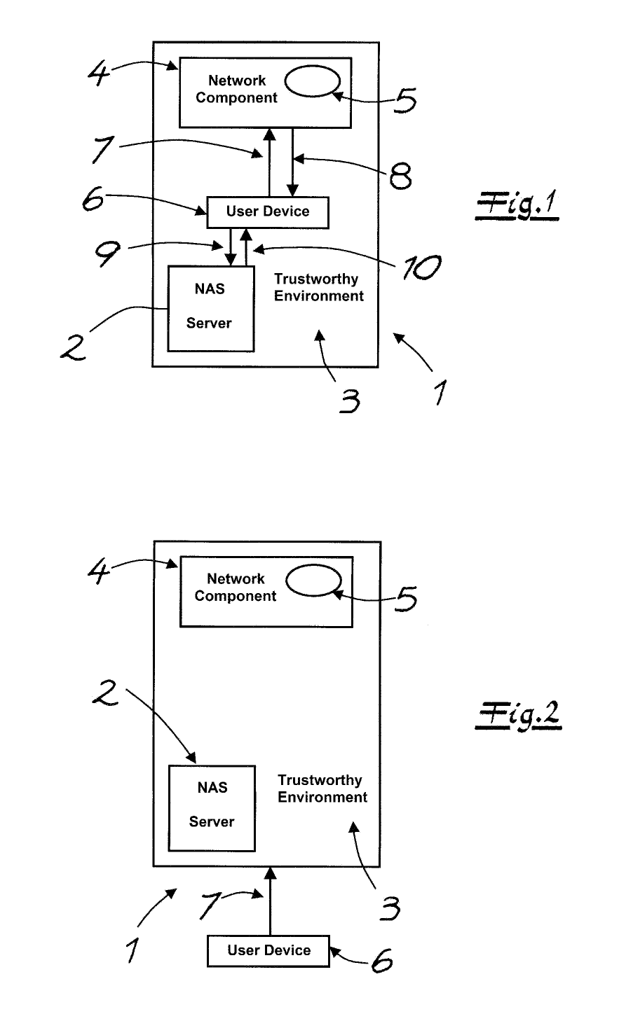

As seen in FIG. 1 a system 1 in which a service in the form of a NAS server (Network Attached Storage Server) 2 is in a defined trustworthy environment 3. As indicated in FIG. 1, a network component 4 is in the trustworthy environment 3. The network components 4 each have a sensor 5 that can determine integration data that is compared with a reference data set stored in the network component 4. Here, the sensor 5 determines a position for the network component 4 and compares the obtained position data with position data contained in the reference data set. Here and in FIGS. 1 and 2, the position data obtained by the sensor 5 and the position data stored in the reference data set match, with the result that the network component 4 determines that it belongs in the trustworthy environment 3 and is integrated into the trustworthy environment 3.

FIG. 1 furthermore shows that a user device 6 has been introduced into the trustworthy environment 3, and the user device 6, preferably and in FIG. 1, determines that it belongs in the trustworthy environment 3 by a comparison with the reference data set stored in the user device 6 by using entry data determined by the user device 6. In the embodiment in FIG. 1, the user device 6 determines that it is a constituent part of the trustworthy environment 3. The user device integrated into the trustworthy environment 3 can now send a password request to the network component 4.

Arrow 7 indicates that the user device 6 is sending the password request to the network component 4 to retrieve a password that is stored in the network component 4. Since both the network component 4 and the user device 6 are each in the trustworthy environment 3, the network component 4 responds to the request 7 by sending a password stored in the network component 4 to the user device 6, as illustrated by arrow 8. Using the password obtained from the network component 4, the user device 6 logs in to the NAS server 2 as shown by arrow 9.

Here, the NAS server 2 decrypts the files stored in the unillustrated file system of the NAS server 2 if the password stored in the file system of the NAS server 2, as illustrated in FIG. 1, matches the password communicated by the user device 6 to the NAS server 2. Arrow 10 represents data transfer between the NAS server 2 and the user device 6.

FIG. 2 shows that the user device 6 is outside the trustworthy environment 3. The user device 6 compares the entry data determined by the user device 6 with the reference data set stored in the user device 6 and in doing so finds there is no match. Since the user device 6 in FIG. 2 is outside the trustworthy environment 3, the result of the password request 7 is that the device cannot reach the network component 4 in the trustworthy environment 3. It is consequently impossible by means of the password request 7 for the user device 6 to request the password that is required to access the NAS server 2. FIG. 2 illustrates that it is impossible to effect access to the NAS server 2 after an unsuccessful proactive password request by the user device 6. FIG. 2 does not illustrate that access to the NAS server 2 can be established by manually entering a password in the user device 6

I claim:

1. A method of gaining secure access to a service in a defined trustworthy environment holding at least one network component, the method comprising the steps of:
saving a password in the network component;
introducing a user device into the trustworthy environment;
contacting the network component with the user device and retrieving the password saved in the network component;
communicating the password from the user device to the service; and
enabling the service for the user device if a password stored in the service matches the password that has been communicated by the user device to the service.

2. The method defined in claim 1, wherein
the trustworthy environment is defined based on a reference data set, and
the reference data set contains at least one data set from the group consisting of position data, LAN data, Bluetooth data, network addresses, GSM wireless data, meteorological data.

3. The method defined in claim 2, further comprising the step of:
comparing the reference data set defining the trustworthy environment with integration data supplied by the network component in order to locate the network component in the trustworthy environment, and
considering the network component to belong to the trustworthy environment only if a specified maximum deviation between the reference data set and the integration data falls below a predetermined value.

4. The method defined in claim 2, further comprising the steps of:
comparing the reference data set defining the trustworthy environment with entry data from the user device in order to introduce the user device into the trustworthy environment; and
considering the user device to belong exclusively to the trustworthy environment only if a specified maximum deviation between the reference data set and the entry data falls below a predetermined value.

5. The method defined in claim 1, further comprising the step of:
the network component refusing to allow the user device to retrieve the password stored in the network component if the user device is located outside the trustworthy environment.

6. The method defined in claim 1, further comprising the step of:
the network component refusing to allow the user device to retrieve the password stored in the network component if the network component is located outside the trustworthy environment.

7. The method defined in claim 1, wherein at least two and preferably a plurality of network components is/are in the trustworthy environment, the method further comprising the step of:
storing respective parts of the password in each of the at least two network components of the trustworthy environment.

8. The method defined in claim 7, further comprising the step of:
the user device retrieving the respective parts of the password from the network components in which the parts of the password are stored.

9. The method defined in claim 8, further comprising the steps of:
combining the parts of the password retrieved by the user device to form the password in the user device.

10. A system for controlling access to a service in a defined trustworthy environment holding at least one network component, system comprising:
at least one network component in the defined trustworthy environment holding a password;
a user device that can be introduced into or integrated into the trustworthy environment;
means for communicating between the user device integrated into the trustworthy environment and the network to component;
means in the user device for retrieving the password in the network component and for communicating the password to the service; and
means in the service for enabled use by the user device if a password stored in the service matches the password that has been communicated by the user device.

11. The system defined in claim 10, wherein the trustworthy environment is preferably a private network.

12. The system defined in one of claims 10, wherein the network component is a passive network component.

13. The system defined in one of claims 10, wherein the network component is an active network component.

14. The system defined in claim 10, wherein the user device is a network-capable device.

15. The system defined in claim 10, wherein the password contains an address of a network component that is in the trustworthy environment.
